(19) United States
(12) Patent Application Publication
(10) Pub. No.: US 2020/0402739 A1
(43) Pub. Date: Dec. 24, 2020

(54) KEY SWITCH

(71) Applicant: OMRON CORPORATION, Kyoto-shi, Kyoto (JP)

(72) Inventors: Hiroaki FUJINO, Okayama-shi (JP); Kazuhira IZAWA, Okayama-shi (JP); Junichi SETO, Okayama-sh (JP); Mamiko NAKA, Okayama-shi (JP)

(73) Assignee: OMRON Corporation, Kyoto-shi, Kyoto (JP)

(21) Appl. No.: 16/643,313

(22) PCT Filed: Jun. 20, 2018
(86) PCT No.: PCT/JP2018/023477

§ 371 Date: Feb. 28, 2020

(30) Foreign Application Priority Data
Sep. 1, 2017 (JP) 2017-168726

(51) Int. Cl. H01H 13/14; H01H 13/02; H01H 13/28

(52) U.S. Cl. CPC H01H 13/14; H01H 2235/01; H01H 13/28; H01H 13/023

(57) ABSTRACT

The key switch includes, a base, a button attached to the base so as to be capable of coming into contact with the base and separating from the base, and a coil spring disposed between the base and the button for urging the button in a direction separating from the base. The coil spring has at least an end turn portion formed at one end, a densely wound portion that is continuous with the end turn portion and compressed in an initial state in which the button is attached to the base so that adjacent windings come into contact with each other, and a coarsely wound portion which is continuous with the densely wound portion and in which a winding pitch is larger than that of the densely wound portion, and in the initial state, adjacent windings are separated from each other.

### TECHNICAL FIELD

The present disclosure relates to a key switch.

### BACKGROUND ART

Patent Document 1 discloses a key switch having a configuration in which a cylindrical guidepost is projected from a base, a light guide is guided on the inner diameter side of the guidepost, and a coil spring disposed on the outer diameter side elastically supports a button so as to be capable of being pushed in.

### PRIOR ART DOCUMENT

### Patent Document

Patent Document 1: CN 104851727 A

### SUMMARY OF THE INVENTION

### Subjects to be Solved by the Invention

However, when the key switch is adopted for a keyboard or the like and used as an operation key of game software, an operation of flipping the key switch from a state of being pushed is sometimes performed. In this case, the coil spring generates vibration in the push-in direction of the key switch. However, since the key switch does not have a mechanism for suppressing vibration, the vibration is not readily attenuated, which causes abnormal noise.

An object of the present disclosure is to provide a key switch that can attenuate the vibration of a coil spring to be used at an early stage and effectively suppress surging.

### Means for Solving the Subjects

One aspect of the key switch of the present disclosure includes: a base; a button attached to the base so as to be capable of coming into contact with the base and separating from the base; and a coil spring disposed between the base and the button for urging the button in a direction separating from the base, in which the coil spring has at least an end turn portion formed at one end, a densely wound portion that is continuous with the end turn portion and compressed in an initial state in which the button is attached to the base so that adjacent windings come into contact with each other, and a coarsely wound portion which is continuous with the densely wound portion and in which a winding pitch is larger than a winding pitch of the densely wound portion, and in the initial state, adjacent windings are separated from each other.

### Effects of the Invention

According to the key switch of the above aspect, when the finger is released from the pushed-in button, the coil spring vibrates, but the windings of the densely wound portion collide with the end turn portion, and the windings of the densely wound portion also collide with each other. As a result, the vibration of the coil spring can be attenuated at an early stage, and surging can be effectively suppressed.

### BRIEF DESCRIPTION OF THE DRAWINGS

FIG. 1 is a perspective view of a key switch according to the present embodiment.

FIG. 2 is a perspective view showing a state where a cover and a button are removed from FIG. 1.

FIG. 3 is an exploded perspective view of the key switch shown in FIG. 1.

FIG. 4A is a perspective view of a base in FIG. 3.

FIG. 4B is a perspective view of FIG. 4A as viewed from below.

FIG. 5 is a perspective view of a light guide in FIG. 3.

FIG. 6 is a perspective view of the cover in FIG. 3.

FIG. 7A is a perspective view of the button in FIG. 3 as viewed from above.

FIG. 7B is a perspective view of the button in FIG. 7A as viewed from below.

FIG. 8 is a perspective view of a coil spring of FIG. 3.

FIG. 9A is a perspective view of a first contact piece of FIG. 3.

FIG. 9B is a perspective view of a second contact piece of FIG. 3.

FIG. 10 is a sectional view taken along a line X-X in FIG. 1.

FIG. 11A is a front view of a coil spring according to another embodiment.

FIG. 11B is a front view of a coil spring according to another embodiment.

FIG. 11C is a front view of a coil spring according to another embodiment.

### MODES FOR CARRYING OUT THE INVENTION

Hereinafter, an embodiment according to the present disclosure will be described with reference to attached drawings.

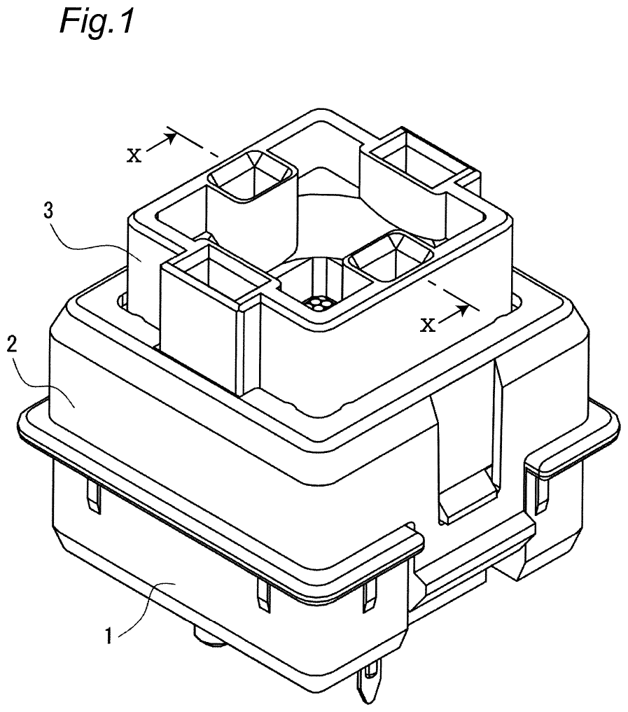

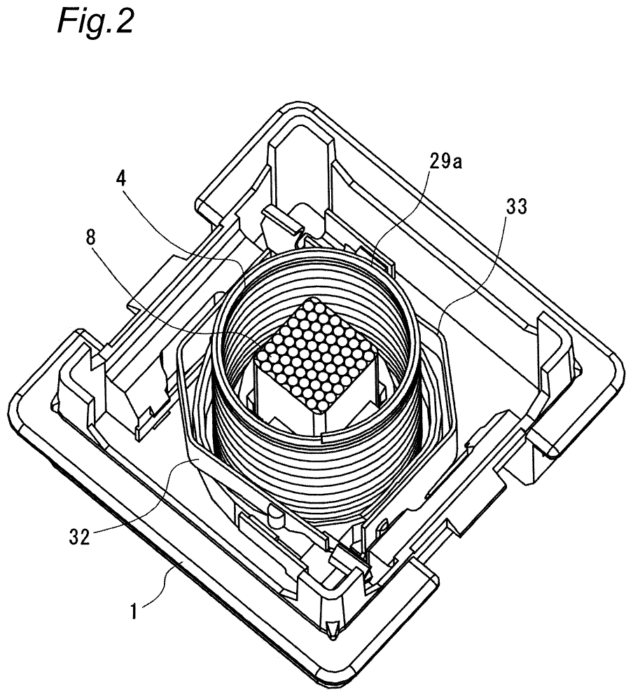

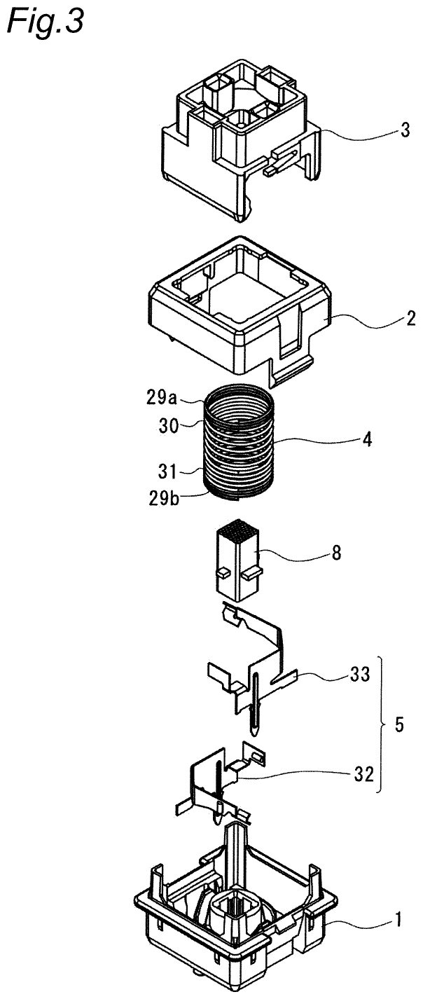

FIG. 1 is a perspective view showing the entire key switch according to the present embodiment. FIG. 2 is a perspective view showing a state where a cover 2 and a button 3 are removed from FIG. 1. FIG. 3 is an exploded perspective view of the key switch of FIG. 1. The key switch includes a base 1, a light guide 8, a cover 2, a button 3, a coil spring 4, and a contact switching mechanism 5. The button 3 is attached to the base 1 so as to be capable of approaching thereto or separating therefrom (that is, so as to be capable of coming into contact therewith and separating therefrom).

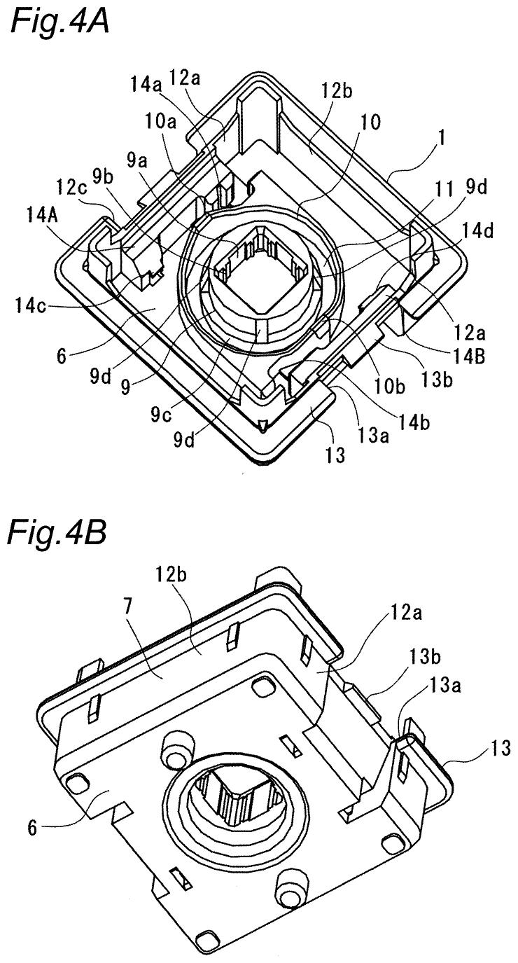

As shown in FIGS. 4A and 4B, the base 1 is made of, for example, a synthetic resin material, and has a bottom 6 and a rectangular frame portion 7. A light guide 8 is provided on the bottom 6.

The bottom 6 has a substantially cylindrical guide portion 9 formed at the center. A center hole 9a of the guide portion 9 is rectangular in a plan view, and on both sides in the left and right direction of each inner side surface of the center hole 9a (that is, the direction parallel to the bottom 6 of the base 1 and the direction perpendicular to a direction in which the button 3 comes into contact with and separates from the base 1), projections 9b extending in the vertical direction (that is, the direction perpendicular to the bottom 6 of the base 1 and the direction in which the button 3 comes into contact with and separates from the base 1) are formed, respectively. The light guide 8 described later is press-fitted into the center hole 9a.

At the lower end of the guide portion 9, a substantially cylindrical pedestal portion 9c having an outer diameter larger than that of the guide portion 9 is formed. In addition, on the outer peripheral surface of the guide portion 9, four inclined portions 9d which gradually expand from the upper end toward the pedestal portion 9c are formed equally in the circumferential direction until the outer diameter becomes the same. Thus, a second end turn portion 29b at the lower end can be positioned on the outer periphery of the pedestal portion 9c while guiding the coil spring 4 described later by the inclined portions 9d.

An annular wall 10 is provided on an outer peripheral side of the guide portion 9, and an annular groove 11 is formed between the guide portion 9 and the annular wall 10. The annular wall 10 projects in a substantially triangular shape upward (i.e., the button 3 side) at two diagonal places, and a first projection guide 10a and a second projection guide 10b extending vertically are formed on the outer peripheral surface thereof, respectively. Parts of contact pieces 32 and 33 described later respectively abut on the first projection guide 10a and the second projection guide 10b, and the positions of the contact pieces 32 and 33 are regulated.

The rectangular frame portion 7 includes two sets of opposing walls 12a and 12b. A flange portion 13 is formed on the outer surfaces of the opposing walls 12a and 12b. A first cut portion 12c is formed by cutting off the upper portion of each of the opposing walls 12a except for both sides. Also, a second cut portion 13a in which a portion of the opposing wall 12a slightly inside the cut portion 12c is cut is formed in the flange portion 13. The lower side of the second cut portion 13a is recessed inward, and a locking protrusion 13b is formed at the center of the upper end. A first guide wall 14A and a second guide wall 14B protruding inward are formed on the inner surface of each opposing wall 12a. The center portions of the first guide wall 14A and the second guide wall 14B are recessed, and a first guide groove 14a and a second guide groove 14b extending vertically are formed in the protruding portions on one end side, respectively. In addition, a pair of upper and lower first holding claws 14c and a pair of upper and lower second holding claws 14d are formed on the protruding portions on the other end sides of the first guide wall 14A and the second guide wall 14B, respectively.

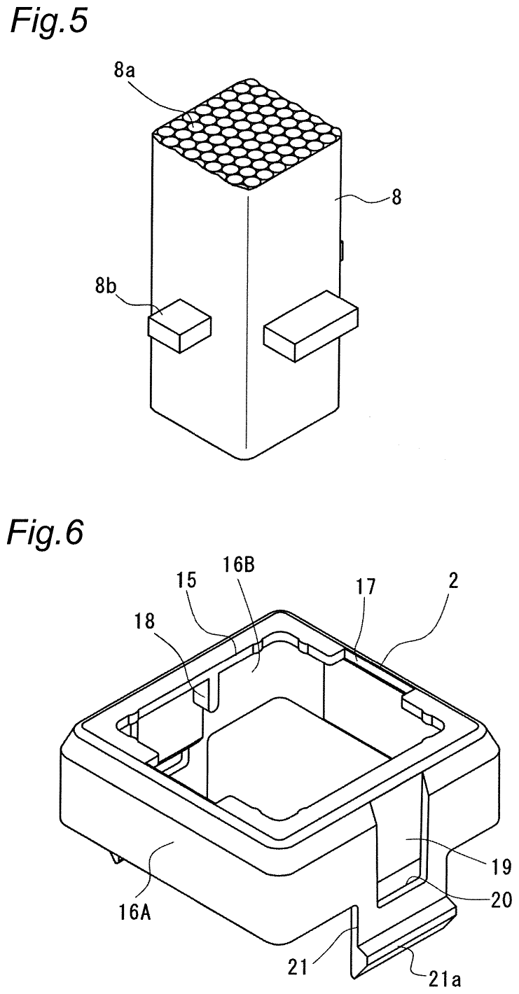

As shown in FIG. 5, the light guide 8 is made of, for example, a synthetic resin material having translucency, and is formed in a substantially rectangular parallelepiped shape as a whole. On the upper surface of the light guide 8, a plurality of convex lenses 8a are formed. The light from an LED (Light Emitting Diode) (not shown), which is a light source, is diffused by these convex lenses 8a. Further, from the three side surfaces of the light guide 8, flat projecting pieces 8b are respectively formed. When the light guide 8 is press-fitted into the center hole 9a formed in the guide portion 9 of the base 1, the projecting pieces 8b abut on the upper surface of the guide portion 9 to regulate the position in the vertical direction.

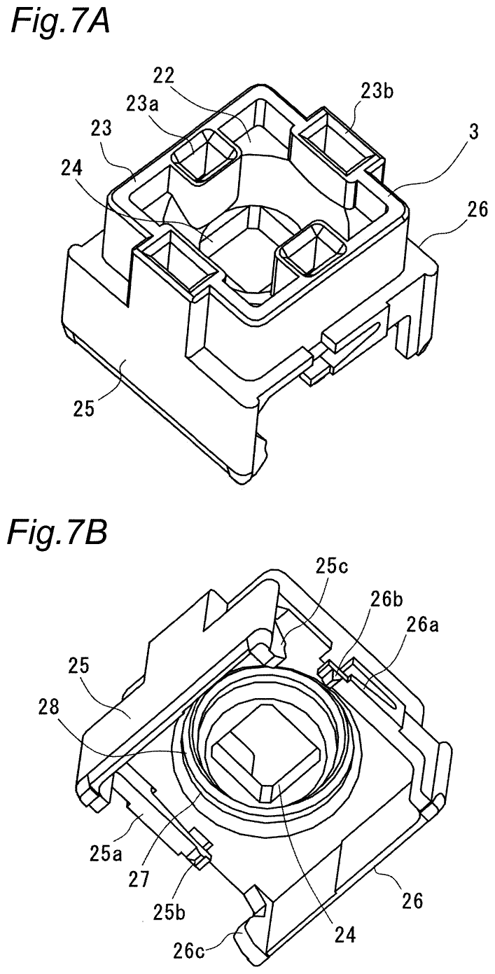

As shown in FIG. 6, the cover 2 is made of, for example, a synthetic resin material and has a substantially rectangular frame shape. The cover 2 is composed of two sets of opposing walls 16A and 16B, and flange portions 15 that protrude inward so as to face each other and approach each other are formed at the upper ends of each set of opposing walls 16A and 16B. In the flange portion 15, a notch 17, at which a second locking receiving portion 23b of the button 3 described below is located, is formed at a position corresponding to the center of the upper end of one of the opposing walls 16A. Further, the flange portion 15 is formed with a contact receiving piece 18 downward from a position corresponding to the center of the upper end of the other opposing wall 16B. A recess 19 is formed on the outer side surface of the opposing wall 16B downward from the center of the upper end, and a locking hole 20 is provided at the lower end. Further, an extending portion 21 extending further downward is provided at the center of the lower end of the opposing wall 16B, and a protrusion 21a is formed on the outer surface of the distal end portion.

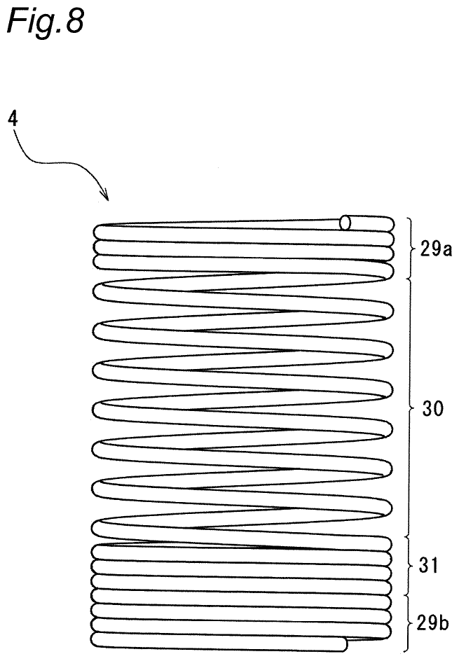

As shown in FIGS. 7A and 7B, the button 3 is made of, for example, a synthetic resin material and has a rectangular shape in plan view. The button 3 is divided into an upper half and a lower half with a partition wall 22 interposed therebetween.

The upper half of the button 3 is formed of a substantially rectangular frame 23, and first locking receiving portions 23a and second locking receiving portions 23b each having a tubular shape are formed at the centers of the opposing side walls, respectively. The first locking receiving portion 23a is formed inside the side wall. The second locking receiving portion 23b is formed so as to straddle the inside and outside of the side wall. A key cap of a keyboard (not shown) is attached using these locking receiving portions 23a and 23b. At the center of the partition wall 22, a rectangular opening 24 communicating vertically is formed. The light guide 8 is disposed in the opening 24, and light from an LED (not shown) is applied to the key cap (not shown) via the light guide 8.

In the lower half of the button 3, a first side wall 25, a second side wall 26 facing the first side wall 25, and an annular groove 27 formed around the opening 24 on the lower surface of the partition wall 22 are formed. A first elastic piece 25a protrudes from one end of the first side wall 25 toward the second side wall 26. A first locking claw 25b is provided at the lower portion of the distal end of the first elastic piece 25a. In addition, a first abutting piece 25c protrudes from the other end of the first side wall 25 toward the second side wall 26. Similarly to the first side wall 25, the second side wall 26 is also provided with a second elastic piece 26a having a second locking claw 26b and a second abutting piece 26c. A guide cylindrical portion 28 is formed between the annular groove 27 and the opening 24. The annular groove 27 holds an upper end portion of the coil spring 4 described later (that is, a first end turn portion 29a described later).

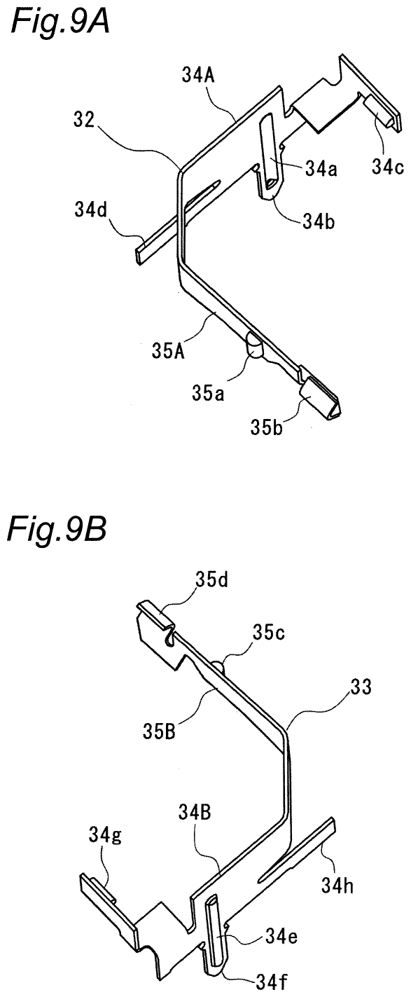

As shown in FIG. 8, the coil spring 4 is formed of a spiral wire, and has the first end turn portion 29a and the second end turn portion 29b respectively formed at both ends (that is, both ends in an axial center direction of the coil spring 4) in the vertical direction (that is, the direction in which the button 3 comes into contact with and separates from the base 1). The first end turn portion 29a and the second end turn portion 29b are portions that apparently do not act as a spring. Here, the first end turn portion 29a and the second end turn portion 29b are each configured by three windings, but may be configured by two windings or four or more windings. When the first end turn portion 29a and the second end turn portion 29b are configured by two or more windings, windings are maintained so as to maintain contact with each other without a gap in both the case of compression and the case of expansion.

The first end turn portion 29a is followed by the coarsely wound portion 30, and the densely wound portion 31 is provided between the coarsely wound portion 30 and the second end turn portion 29b. In an initial state in which the button 3 is not pressed in, the coil spring 4 is slightly compressed between the base 1 and the button 3. The coarsely wound portion 30 is a portion where a gap is formed between adjacent windings in this initial state. The coarsely wound portion 30 is located in a space formed between the base 1 and the button 3. The densely wound portion 31 has a gap formed between adjacent windings in a natural length state in which no compressive force acts on the coil spring 4, but in the initial state, adjacent windings are in contact with each other, and no gap is formed in this portion. The number of turns of the densely wound portion 31 is four, which is the same as the number of turns of the second end turn portion 29b. The densely wound portion 31 is disposed in the annular groove 11 of the base 1. When the coil spring 4 has a natural length, there is a relationship of Pz<Pm<Ps when the winding pitch of the first end turn portion 29a and the second end turn portion 20b is Pz, the winding pitch of the densely wound portion 31 is Pm, and the winding pitch of the coarsely wound portion 30 is Ps. In addition, the pitch of the windings at each portion is equal, but as a whole it is unequal.

When the first end turn portion 29a is disposed in the annular groove 27 of the button 3 and the second end turn portion 29b is disposed in the annular groove 11 of the base 1, the coil spring 4 with the above-described configuration is disposed between the button 3 and the base 1 and urges the button 3 upward with respect to the base 1. Note that the coil spring 4 may be turned upside down so that the first end turn portion 29a is disposed in the annular groove 11 of the base 1 and the second end turn portion 29b is disposed in the annular groove 27 of the button 3.

The contact switching mechanism 5 includes a pair of contact pieces, that is, a first contact piece 32 and a second contact piece 33, which are formed by pressing and bending a flat copper alloy.

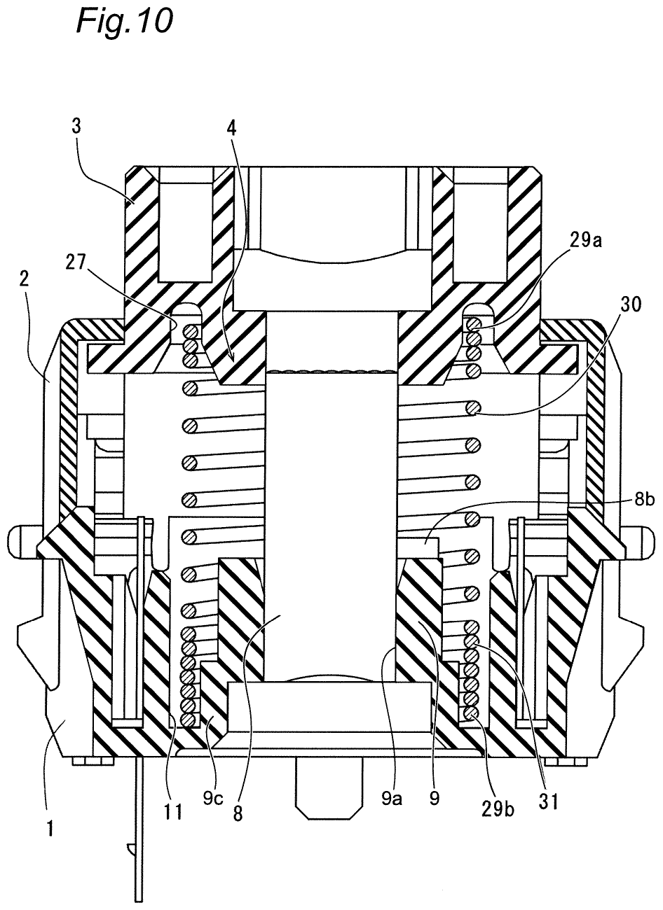

As shown in FIGS. 9A and 9B, the first contact piece 32 includes a first fixed piece portion 34A and a first movable piece portion 35A. The first fixed piece portion 34A is formed with a first press-fit portion 34a bulging laterally, and a portion protruding downward serves as a first terminal portion 34b. One end side of the first fixed piece portion 34A is bent at approximately 90° at two places, and a first fixed contact 34c is integrated with the distal end flat surface. The other end side of the first fixed piece portion 34A is a first attached piece 34d whose lower half protrudes as it is. The first attached piece 34d is held by the first holding claws 14c of the base 1. The first movable piece portion 35A is bent downward from the upper half on the other end side of the first fixed piece portion 34A and then extends laterally. A first movable contact 35a provided on a side surface and a first press receiving portion 35b that is curved and protrudes laterally are formed on the distal end side of the first movable piece portion 35A.

The second contact piece 33 has substantially the same configuration as the first contact piece 32, and includes a second press-fit portion 34e corresponding to the first press-fit portion 34a, a second terminal portion 34f corresponding to the first terminal portion 34b, a second fixed contact 34g corresponding to the first fixed contact 34c, and a second fixed piece portion 34B having a second attached piece 34h corresponding to the first attached piece 34d. However, the second movable piece portion 35B differs from the first movable piece portion 35A in the extending direction and in that the second movable piece portion 35B extends laterally after going upward from the second fixed piece portion 34B. The second movable contact 35c and the second press receiving portion 35d are formed on the distal end side of the second movable piece portion 35B in the same manner as the first contact piece 32.

Next, a method of assembling the key switch with the above configuration will be described.

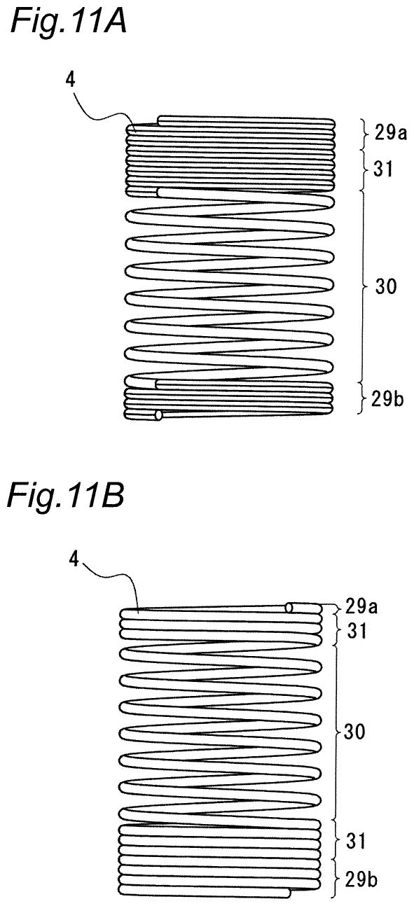

The lower end of the light guide 8 is press-fitted into the center hole 9a formed in the guide portion 9 of the base 1. As shown in FIG. 10, the position of the light guide 8 in the vertical direction is regulated by the projecting piece 8b formed on the side surface abutting on the upper surface of the guide portion 9. Thus, the base 1 including the light guide 8 is obtained.

The coil spring 4 is disposed on the outer peripheral side of the guide portion 9 of the base 1. The coil spring 4 is disposed on the outer periphery of the pedestal portion 9c with the second end turn portion 29b guided to the inclined portion 9d of the guide portion 9. Therefore, the densely wound portion 31 is located above the pedestal portion 9c, the coarsely wound portion 30 is located above the densely wound portion 31, and the first end turn portion 29a is located above the coarsely wound portion 30. As described above, the coil spring 4 disposed on the outer peripheral side of the guide portion 9 is disposed at a position where it does not interfere with the light guide 8 attached to the guide portion 9. That is, the coil spring 4 is disposed outside the light guide space formed between the button 3 and the base 1. Therefore, the light emitted from the LED can be applied to the key cap via the light guide 8 without being blocked by the coil spring 4.

The first contact piece 32 and the second contact piece 33 are assembled to the base 1.

In the assembly of the first contact piece 32, the first press-fit portion 34a is inserted into the first guide groove 14a of the base 1, and the first attached piece 34d is held by the first holding claws 14c. At this time, the first projection guide 10a formed on the annular wall 10 is pressed against the first fixed piece portion 34A of the first contact piece 32. Thereby, the assembled state of the first contact piece 32 to the base 1 is stabilized. The first terminal portion 34b protrudes from the lower surface of the base 1.

In the assembly of the second contact piece 33, in the same manner as the first contact piece 32, the second press-fit portion 34e is inserted into the second guide groove 14b of the base 1, and the second attached piece 34h is held by the second holding claws 14d. The second projection guide 10b formed on the annular wall 10 is pressed against the second fixed piece portion 34B of the second contact piece 33. In this state, the second movable contact 35c of the second contact piece 33 closably faces the first fixed contact 34c of the first contact piece 32, and the first movable contact 35a of the first contact piece 32 closably faces the second fixed contact 34g of the second contact piece 33.

The button 3 is placed so as to cover the guide portion 9 of the base 1. At this time, the upper end portion of the coil spring 4, that is, the first end turn portion 29a is located in the annular groove 27 of the button 3. Subsequently, the cover 2 is put on the base 1. The cover 2 is attached to the base 1 by locking the locking protrusion 13b of the base 1 into the locking hole 20 formed in the extending portion 21. At this time, the first abutting piece 25c of the button 3 abuts on the contact receiving piece 18 of the cover 2, and the upward movement of the button 3 is regulated.

The key switch assembled in this manner is used by mounting it on a printed circuit board (not shown) on which LEDs are mounted. At this time, the first terminal portion 34b and the second terminal portion 34f are inserted and fixed in the terminal holes formed in the printed circuit board. Further, a key cap (not shown) is attached to the button 3 to obtain a keyboard.

Next, the operation of the key switch with the above configuration will be described.

In an initial state in which a key cap (not shown) is not pushed in, the button 3 is urged upward by the coil spring 4 and positioned at the projecting position, as shown in FIG. 10. In this state, the first abutting piece 25c of the button 3 abuts on the first press receiving portion 35b of the first contact piece 32, elastically deforms the first movable piece portion 35A, and makes the first movable contact 35a separate from the second fixed contact 34g of the second contact piece 33. Further, the second abutting piece 26c of the button abuts on the second press receiving portion 35d of the second contact piece 33, elastically deforms the second movable piece portion 35B, and makes the second movable contact 35c separate from the first fixed contact 34c of the first contact piece 32. Therefore, the first contact piece 32 and the second contact piece 33 are not electrically connected. Further, in the coil spring 4, a gap is formed between the adjacent windings of the coarsely wound portion 30, but the adjacent windings of the densely wound portion 31 are in contact with each other, and a gap is not formed.

When the button 3 is pressed down via the key cap against the urging force of the coil spring 4, the pressed state of the first press receiving portion 35b by the first abutting piece 25c of the button 3 is released at the first contact piece 32. Further, at the second contact piece 33, the pressed state of the second press receiving portion 35d by the second abutting piece 26c of the button 3 is released. As a result, the first movable contact 35a contacts the second fixed contact 34g, and the second movable contact 35c contacts the first fixed contact 34c. That is, the first contact piece 32 and the second contact piece 33 are electrically connected, and it is possible to detect that a key operation has been performed. At this time, in the coil spring 4, the interval between the adjacent windings in the coarsely wound portion 30 is reduced.

Here, when the pressed state of the key cap is released, the button 3 moves upward by the urging force of the coil spring 4. When the button 3 moves upward, the coil spring 4 vibrates in the axial center direction (that is, the direction in which the button 3 comes into contact with and separates from the base 1). At this time, the state changes from the contact state in which the densely wound portion 31 contacts the adjacent windings to the separated state in which a gap is formed between the windings, and thereafter, the contact state and the separated state are repeated. As a result, the winding of the adjacent densely wound portion 31 collides with the second end turn portion 29b. Further, adjacent windings collide with each other also in the densely wound portion 31. Thereby, the elastic energy of the coil spring 4 is rapidly consumed, and the vibration of the coil spring 4 can be attenuated at an early stage. That is, it is possible to suppress the occurrence of surging. Here, although the second end turn portion 29b is configured with three windings, the occurrence of surging can be suppressed by configuring the second end turn portion 29b with two or more windings.

Note that the present disclosure is not limited to the configuration described in the above embodiment, and various modifications are possible.

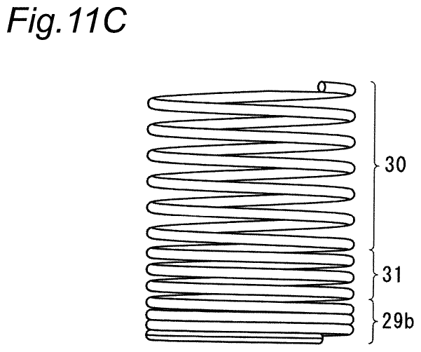

In the above embodiment, the coil spring 4 has a configuration in which the densely wound portion 31 is continuous with the second end turn portion 29b, but may have a configuration in which the densely wound portion 31 is continuous with the first end turn portion 29a. That is, as shown in FIG. 11A, the coil spring 4 may have a configuration in which the first end turn portion 29a, the densely wound portion 31, the coarsely wound portion 30, and the second end turn portion 29b are connected in this order.

Further, it may have a configuration in which the densely wound portion 31 is continuous with each of the first end turn portion 29a and the second end turn portion 29b. That is, as shown in FIG. 11B, the coil spring 4 may have a configuration in which the first end turn portion 29a, the densely wound portion 31, the coarsely wound portion 30, the densely wound portion 31, and the second end turn portion 29b are connected in this order.

Furthermore, it may have a configuration in which an end turn portion is provided only on one end side of the coil spring 4. That is, as shown in FIG. 11C, the coil spring 4 may have a configuration in which the coarsely wound portion 30, the densely wound portion 31, and the second end turn portion 29b are connected in this order.

In any case, similarly to the above-described embodiment, surging at the coil spring 4 generated by releasing the pressed state of the key cap and moving the button 3 upward can be suppressed according to the same principle as the above-described embodiment.

As described above, various embodiments of the present disclosure have been described in detail with reference to the drawings. Finally, various aspects of the present disclosure will be described. In the following, description will be given with reference numerals attached as examples.

The key switch according to the first aspect of the present disclosure includes: a base (1); a button (3) attached to the base (1) so as to be capable of coming into contact with the base (1) and separating from the base (1); and a coil spring (4) disposed between the base (1) and the button (3) for urging the button (3) in a direction separating from the base (1), in which the coil spring (4) has at least an end turn portion (29b) formed at one end, a densely wound portion (31) that is continuous with the end turn portion (29b) and compressed in an initial state in which the button (3) is attached to the base (1) so that adjacent windings come into contact with each other, and a coarsely wound portion (30) which is continuous with the densely wound portion (31) and in which a winding pitch is larger than that of the densely wound portion (31), and in the initial state, adjacent windings are separated from each other.

With this configuration, when the pressed state of the button is released, the button returns to the original position by the urging force of the coil spring. At this time, the coil spring vibrates, but the winding of the densely wound portion adjacent to the end turn portion collides with the end turn portion. Further, the windings of the densely wound portion also collide with each other. Thereby, the elastic energy of the coil spring is consumed, and the vibration is rapidly attenuated. As a result, the occurrence of surging can be suppressed.

In the key switch according to the second aspect of the present disclosure, the coil spring (4) includes an end turn portion (29a) at the other end.

In the key switch according to the third aspect of the present disclosure, the coil spring (4) includes a densely wound portion (31) between the end turn portion (29a) at the other end and the coarsely wound portion (30).

With this configuration, the elastic energy can be consumed by the collision between the wires also at the other end of the coil spring, similarly to the one end, and the occurrence of surging can be further suppressed by attenuating the vibration.

In the key switch according to the fourth aspect of the present disclosure, the end turn portion (29a or 29b) formed at one end or the other end of the coil spring (4) is configured by two or more windings.

With this configuration, the occurrence of surging can be further suppressed.

In the key switch according to the fifth aspect of the present disclosure, the number of windings of the end turn portion (29a or 29b) and the number of windings of the densely wound portion (31) are equal.

With this configuration, the rigidity of the end turn portion and the rigidity of the densely wound portion in a state where the adjacent windings are bonded to each other can be made substantially the same. As a result, the coil spring vibrates and the winding of the densely wound portion collides with the end turn portion, and the windings of the densely wound portion collide with each other, thereby increasing the consumption of elastic energy to further easily attenuate the vibration.

In the key switch according to the sixth aspect of the present disclosure, the end turn portion (29a) contacts the button (3).

With this configuration, when the pressed state of the button is released to return the button to the original position by the urging force of the coil spring, the winding of the densely wound portion can first collide with the end turn portion. Therefore, the vibration of the coil spring can be attenuated at an earlier stage.

In the key switch according to the seventh aspect of the present disclosure, the end turn portion (29b) is in contact with the base (1).

In the key switch according to the eighth aspect of the present disclosure, the coil spring (4) is disposed outside a light guide space formed between the button (3) and the base (1).

With this configuration, even when the configuration of the coil spring is changed to suppress the occurrence of surging, the illumination state of the key switch can be maintained in a good state because the coil spring does not block light.

In addition, by appropriately combining any of the above-described various embodiments or modifications, it is possible to achieve the effects of the respective embodiments or modifications. In addition, a combination of the embodiments, a combination of the examples, or a combination of the embodiment and the example is possible, and a combination of the features in the different embodiments or the examples is also possible.

Although the present disclosure has been fully described in connection with preferred embodiments with reference to the accompanying drawings, various variations and modifications will be apparent to those skilled in the art. It is to be understood that such variations and modifications are included therein unless they depart from the scope of the present disclosure as set forth in the appended claims.

### INDUSTRIAL APPLICABILITY

The key switch according to the present disclosure can be employed for a keyboard or the like.

### DESCRIPTION OF REFERENCE SIGNS

1: Base
2: Cover
3: Button
4: Coil spring
5: Contact switching mechanism
6: Bottom
7: Rectangular frame portion
8: Light guide
8a: Convex lens
8b: Projecting piece
9: Guide portion
9a: Center hole
9b: Projection
9c: Pedestal portion
9d: Inclined portion
10: Annular wall
10a: First projection guide
10b: Second projection guide
11: Annular groove
12a, 12b: Opposing wall
12c: First cut portion
13: Flange portion
13a: Second cut portion
13b: Locking protrusion
14A: First guide wall
14B: Second guide wall
14a: First guide groove
14b: Second guide groove
14c: First holding claw
14d: Second holding claw
15: Flange portion
16A, 16B: Opposing wall
17: Notch
18: Contact receiving piece
19: Recess
20: Locking hole
21: Extending portion
21a: Protrusion
22: Partition wall
23: Frame
23a: First locking receiving part
23b: Second locking receiving portion
24: Opening
25: First side wall
25a: First elastic piece
25b: First locking claw
25c: First abutting piece
26: Second side wall
27: Annular groove
28: Guide cylindrical portion
29a: First end turn portion
29b: Second end turn portion
30: Coarsely wound portion
31: Densely wound portion
32: First contact piece
33: Second contact piece
34A: First fixed piece portion
34B: Second fixed piece portion
34a: First press-fit portion
34b: First terminal portion
34c: First fixed contact
34d: First attached piece
34e: Second press-fit portion
34f: Second terminal portion
34g: Second fixed contact
34h: Second attached piece
35A: First movable piece portion
35B: Second movable piece portion
35a: First movable contact
35b: First press receiving portion
35c: Second movable contact
35d: Second press receiving portion

1. The key switch comprising:
a base;
a button attached to the base so as to be capable of coming into contact with the base and separating from the base; and
a coil spring disposed between the base and the button for urging the button in a direction separating from the base, wherein the coil spring has at least an end turn portion formed at one end, a densely wound portion that is continuous with the end turn portion and compressed in an initial state in which the button is attached to the base so that adjacent windings come into contact with each other, and a coarsely wound portion which is continuous with the densely wound portion and in which a winding pitch is larger than that of the densely wound portion, and in the initial state, adjacent windings are separated from each other.

2. The key switch according to claim 1, wherein the coil spring comprises an end turn portion at other end.

3. The key switch according to claim 2, wherein the coil spring comprises a densely wound portion between the end turn portion at the other end and the coarsely wound portion.

4. The key switch according to claim 1, wherein the end turn portion formed at one end or other end of the coil spring is configured by two or more windings.

5. The key switch according to claim 1, wherein a number of windings of the end turn portion and a number of windings of the densely wound portion are equal.

6. The key switch according to claim 1, wherein the end turn portion contacts the button.

7. The key switch according to claim 1, wherein the end turn portion is in contact with the base.

8. The key switch according to claim 1, wherein the coil spring is disposed outside a light guide space formed between the button and the base.
